(19) United States
(12) Patent Application Publication
(10) Pub. No.: US 2025/0358245 A1
(43) Pub. Date: Nov. 20, 2025

(54) Virtual Port Switching for Multi-drop Networks

(71) Applicant: Microchip Technology Inc., Chandler, AZ (US)

(72) Inventor: Kristian Ehlers, Copenhagen (DK)

(73) Assignee: Microchip Technology Inc., Chandler, AZ (US)

(21) Appl. No.: 19/211,356

(22) Filed: May 19, 2025

Related U.S. Application Data
(60) Provisional application No. 63/649,728, filed on May 20, 2024.

(51) Int. Cl. H04L 49/00; H04L 49/351

(52) U.S. Cl. CPC H04L 49/70; H04L 49/351

(57) ABSTRACT

An apparatus includes an upstream network interface, a downstream network interface to configured to connect to N follower devices on a shared network bus, and an Ethernet forwarder circuit with at least N+1 virtual ports, The N+1 virtual ports include a given virtual port for a given one of the N follower devices and at least one given virtual port for a group of two or more of the N follower devices.

### PRIORITY

This application claims priority to U.S. Provisional Patent Application No. 63/649,728 filed May 20, 2024, the contents of which are hereby incorporated in their entirety.

### FIELD OF THE INVENTION

The present disclosure relates to networking of electronic devices and, more particularly, to virtual port switching for shared multi-drop networks such as 10Base-T1s. The use of a virtual port for the transmission of traffic towards different destination nodes on a shared bus architecture may cause a shared bus to operate in an equivalent manner to a switched network topology.

### BACKGROUND

In a multi-drop or shared network scheme such as 10Base-T1s, bus all end-nodes receive all Ethernet frames independently of which end-node a specific Ethernet frame targets. Inventors of examples of the present disclosure have discovered that this may be a security issue in some applications, such as automotive applications, and therefore MACsec may be deployed on the shared bus. However, inventors of examples of the present disclosure have also discovered that deployment of MACsec on the shared bus may not be efficient or scalable. For example, given a main or controller node and 8 follower nodes, in order to communicate securely between all node permutations, a total of 72 secure channels would be used. Additionally, deploying security measures like Media Access Control security (MACsec) on shared bus networks may not be as straightforward or scalable as in traditional switched networks. For example, in a scenario with multiple nodes, the number of secure channels required for comprehensive communication between all node pairs could increase substantially, potentially leading to implementation complexities and resource constraints.

Examples of the present disclosure may address one or more of these issues.

### BRIEF DESCRIPTION OF THE DRAWINGS

FIG. 1 is an illustration of a switched Ethernet topology network, according to examples of the present disclosure.

FIG. 2 is an illustration of a block diagram of a network system, according to examples of the present disclosure.

FIG. 3 illustrates a block diagram of a network system showing a controller and follower node/device implementation, according to examples of the present disclosure.

FIG. 4 is an illustration of a block diagram of a virtual port switching system for a shared network bus, according to examples of the present disclosure.

FIG. 5 is an illustration of operation of a virtual port switching system for unicast forwarding, according to examples of the present disclosure.

FIG. 6 is an illustration of operation of a virtual port switching system for broadcast forwarding, or flooding, wherein each node may have a single SC from the controller to a given node, according to examples of the present disclosure.

FIG. 7 is an illustration of operation of a virtual port switching system for broadcast forwarding, or flooding, wherein each node may share an additional SC from the controller to the given node for broadcasting, according to examples of the present disclosure.

FIG. 8 is an illustration of operation of a virtual port switching system for follower-to-follower communication, wherein one SC is provided for each follower, according to examples of the present disclosure.

FIG. 9 is an illustration of the operation of a virtual port switching system for follower-to-follower communication, wherein three SCs are provided for each follower, according to examples of the present disclosure.

### DETAILED DESCRIPTION

Examples of the present disclosure may utilize virtual ports to emulate the operation of a switched network over a shared or multi-drop network. Such virtual ports may be used to deploy MACsec-enabled transmission of data over the shared or multi-drop network. The virtual port usage may also use timing (IEEE802.1as) and quality of service over shared bus to cause the Ethernet switch forwarding towards the shared bus operating analogous to a switched network topology where MACsec, timing and QoS are already deployed.

Examples of the present disclosure may enable a controller node with 8 follower nodes to support 8 1:1 secure channels (one from the controller to the individual 8 follower nodes), wherein each follower node might only support a single secure channel back to the controller. Thus, in such a case, only 16 secure channels might be used for a 9-node shared bus.

Examples of the present disclosure may relate to virtual port switching for shared multi-drop networks, such as those using 10Base-T1s technology. Virtual port switching may enable emulation of a switched network topology over a shared or multi-drop network architecture. This approach may allow for efficient deployment of security protocols, such as MACSec as well as improved timing and quality of service capabilities on shared bus networks.

The apparatus described herein may be used in any suitable context where applying switched network techniques to a multi-drop or shared network is desirable. For example, the apparatus may be implemented in an in-vehicle network (IVN) using 10BASE-T1s technology to connect to small devices, sensors, or other suitable electronic components in a vehicle. Such devices may not be suitable for traditional switched networking due to the overhead typically associated with implementing switched networks at the device level.

By utilizing virtual ports, the apparatus may enable secure and efficient communication between a controller node and multiple follower devices on a shared bus. This approach may provide benefits such as reduced bandwidth requirements, simplified cabling, and lower power consumption compared to traditional switched network topologies.

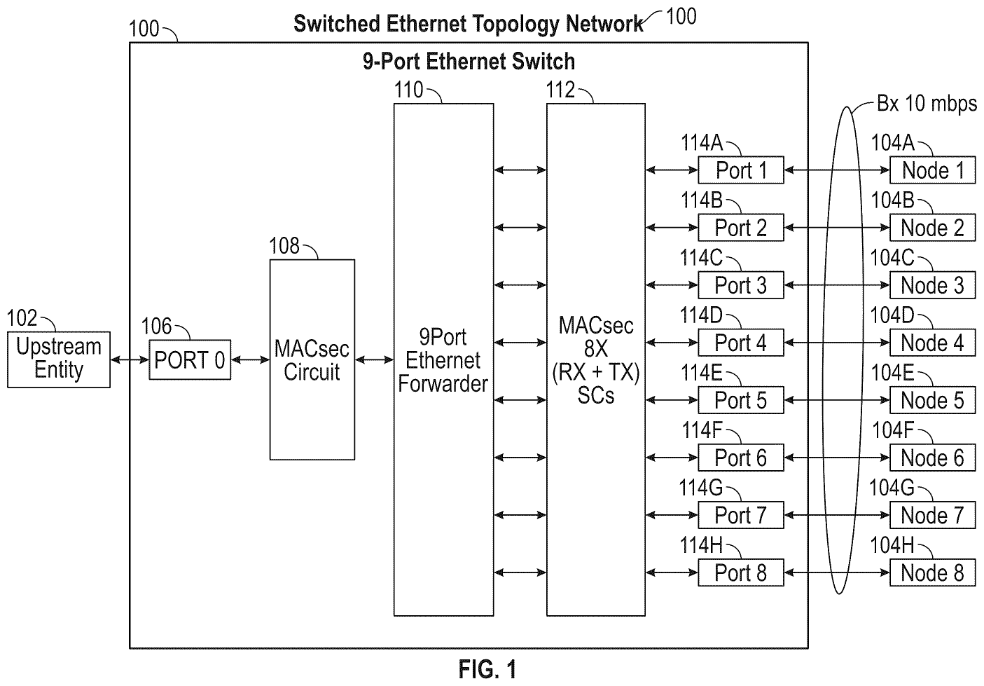

FIG. 1 is an illustration of a switched Ethernet topology network 100, according to examples of the present disclosure.

The system may be used in any suitable context or application for applying switched network techniques that are to be used instead in a multi-drop or shared network. For example, the apparatus may be used in an in-vehicle network (IVN) using 10BASE-T1s technology to connect to small devices, sensors, or other suitable electronic devices in a vehicle. Such devices might not be suitable for switched networking in terms of the overhead typically used to implement switched networks at the device level. These devices downstream on a shared or multi-drop network from the apparatus may be referred to as followers. The followers may be implemented in any suitable manner, and by any suitable device.

The switched Ethernet topology network 100 may include an upstream entity 102 connected to a port 0 106. The port 0 106 may be connected to a MACsec circuit 108, which may be configured to provide security functions for communications on network 100. The MACsec circuit 108 may be connected to an Ethernet forwarder 110, which may be configured to manage data routing within the network 100.

The Ethernet forwarder 110 may be connected to a MACsec circuit 112. The MACsec circuit 112 may be configured to establish and maintain secure communication channels between various components of the network 100. A secure channel may be established between the controller node and a given follower by the MACsec circuit. The secure channel may cause the frame or other information for the given follower may be encoded with a key or other mechanism for which the given follower has a corresponding key or other mechanism so that the given follower may decrypt the information.

The MACsec circuit 112 may be connected to multiple ports, including a port 1 114A, a port 2 114B, a port 3 114C, a port 4 114D, a port 5 114E, a port 6 114F, a port 7 114G, and a port 8 114H. Each of these ports may be connected to a corresponding node, including a node 1 104A, a node 2 104B, a node 3 104C, a node 4 104D, a node 5 104E, a node 6 104F, a node 7 104G, and a node 8 104H, respectively.

The switched Ethernet topology network 100 may be implemented using any suitable hardware components. The upstream entity 102 may be any suitable network device capable of sending and receiving data, such as a router, switch, or server. The nodes 104A-104H may be any suitable network-enabled devices, such as computers, sensors, or other electronic devices.

The ports 106 and 114A-114H may be implemented using any suitable type of network interface, such as Ethernet ports. These ports may be configured to transmit and receive data packets between the connected devices.

The MACsec circuit 108 may be implemented using any suitable hardware or software components capable of providing Media Access Control security functions. The MACsec circuit 108 may be configured to encrypt and authenticate data packets transmitted over the network 100.

The Ethernet forwarder 110 may be implemented using any suitable switching or routing hardware. The Ethernet forwarder 110 may be configured to direct data packets between the various ports and nodes of the network 100 based on destination addresses.

The MACsec circuit 112 may be implemented using any suitable hardware or software components capable of establishing and maintaining secure communication channels. The MACsec circuit 112 may be configured to create encrypted tunnels between nodes or groups of nodes in the network 100.

In the switched Ethernet topology network 100, data may be transmitted between the upstream entity 102 and any of the nodes 104A-104H through the Ethernet forwarder 110 and MACsec circuit 112. This topology may allow for efficient and secure communication between devices on the network 100.

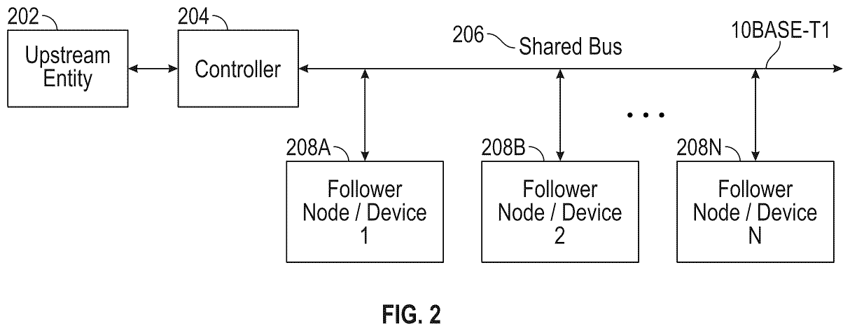

FIG. 2 is an illustration of a block diagram of a network system 200, according to examples of the present disclosure. The system may be an outermost edge of a larger network such as an Ethernet network using 10BASE-T1s technology to connect to small devices, sensors, etc. This system may cause the shared bus topology to operate as if it is a switched Ethernet topology and thus can send and receive from Ethernet elements upstream. FIG. 2 may illustrate a possible alternative to the system of FIG. 1.

The system may include an upstream entity 202 connected to a controller 204. The controller 204 may interface with a shared bus 206, which may provide connectivity to multiple follower devices including a first follower device 208A, a second follower device 208B, and extending to an nth follower device 208N.

The upstream entity 202 may be any suitable device capable of sending and receiving data over a network, such as a router, switch, or server. The upstream entity 202 may be connected to the controller 204 through any suitable network interface, which may serve as an upstream network interface for the system.

The controller 204 may include any suitable components for managing communication between the upstream entity 202 and the follower devices 208A, 208B, 208N. The controller 204 may include an Ethernet forwarder circuit with at least N+1 virtual ports, where N may be the number of follower devices connected to the shared bus 206. The N+1 virtual ports may include a given virtual port for a given one of the N follower devices, as well as at least one given virtual port for a group of two or more of the N follower devices. Controller 204 may be implemented with analog circuitry, digital circuitry, an application-specific integrated circuit, a field-programmable gate array, a programmable logic device, reconfigurable logic, instructions for execution by a processor, or any suitable combination thereof.

The shared bus 206 may be implemented using any suitable shared network technology, such as 10BASE-T1s. The shared bus 206 may enable communication between the controller 204 and the follower devices 208A, 208B, 208N. The controller 204 may manage data transmission between the upstream entity 202 and the follower devices over the shared bus 206.

The follower devices 208A, 208B, 208N may be connected to the shared bus 206 in a multi-drop configuration, allowing them to receive communications from the controller 204. The shared bus 206 may provide a common communication medium through which the controller 204 can transmit data to any of the follower devices 208A, 208B, 208N. The follower devices may be any suitable electronic devices, such as sensors, actuators, or other components in an in-vehicle network. Any suitable number of follower devices 208 may be included.

The controller 204 may interface between the upstream entity 202 and the shared bus 206, facilitating data flow between the upstream entity 202 and the follower devices 208A, 208B, 208N. The controller 204 may manage communications over the shared bus 206 to coordinate data transmission between components of the system. Unlike a traditional switched topology where each device may have a dedicated physical connection to a switch, this virtual port switching system may use a shared bus architecture. The controller 204 may emulate a switched topology by using virtual ports to manage communication with individual follower devices over the shared bus 206. This approach may allow for more efficient use of network resources and simplified physical infrastructure.

The virtual ports in the controller 204 may be implemented using any suitable combination of hardware and software. For example, the virtual ports may be realized through network interface hardware with virtualization support, combined with software, firmware, or analog/digital modules that manage the mapping between virtual ports and physical devices on the shared bus.

The system may include a downstream network interface configured to connect to the N follower devices on the shared network bus 206. This downstream network interface may be implemented as part of the controller 204 and may include any suitable hardware and software components for managing communication over the shared bus 206.

The controller 204 may be implemented with analog circuitry, digital circuitry, a field-programmable gate array (FPGA), application-specific integrated circuit (ASIC), programmable logic device, combinatorial logic, instructions for execution by a processor, or any suitable combination thereof. The controller 204 may be implemented using various hardware and software components to manage communication between the upstream entity and follower devices on the shared bus. In some aspects, the controller 204 may include a microprocessor or microcontroller unit (MCU) to execute control logic and manage network operations. This processing unit may be coupled with memory components such as RAM and ROM to store operational data and firmware.

The controller 204 may incorporate a network interface circuit to connect with the upstream entity 202. This interface may support protocols like Ethernet or other suitable networking standards. For interfacing with the shared bus 206, the controller 204 may include a physical layer (PHY) transceiver compatible with the 10BASE-T1s specification or other relevant shared bus technologies. In some implementations, the controller 204 may utilize a field-programmable gate array (FPGA) or application-specific integrated circuit (ASIC) to implement the Ethernet forwarder circuit and virtual port functionality. These programmable logic devices may allow for flexible configuration of virtual ports and efficient packet processing.

The controller 204 may also include a security module or circuit to handle encryption and authentication tasks. This module may implement protocols such as MACsec to secure communications over the shared bus. In some cases, the security functions may be integrated into the main processing unit or implemented as a separate co-processor. Software running on the controller 204 may include a real-time operating system (RTOS) to manage tasks and resources efficiently. The software stack may also include drivers for the network interfaces, protocol stacks for Ethernet and other relevant standards, and application-level logic to implement the virtual port switching functionality.

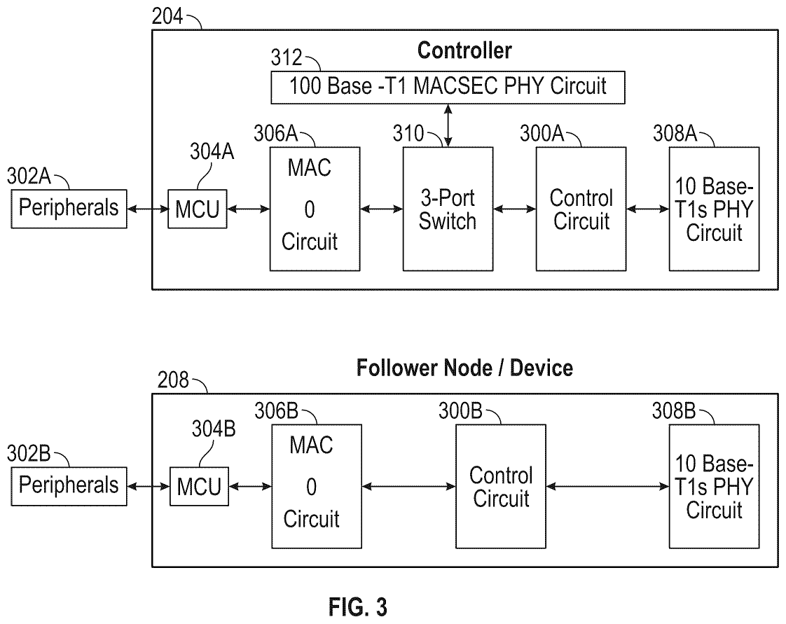

FIG. 3 illustrates a block diagram of a network system showing a controller and follower node/device implementation, according to examples of the present disclosure.

The controller 204 may include several components for managing communication between an upstream entity and follower devices on a shared bus. A 100 Base T1 MACSec physical interface circuit 312 may be included in the controller 204 to provide secure communication capabilities for the upstream network.

The media access circuit 306A may be connected to a 3-port switch circuit 310. The switch circuit 310 may be configured to manage traffic flow between different interfaces within the controller 204. The switch circuit 310 may be further connected to a control circuit 300A and then to a 10 Base T1 physical layer circuit 308A. The control circuit 300A may be responsible for handling protocol processing and management functions for the controller 204. The 10 Base T1 physical layer circuit 308A may serve as the downstream network interface, enabling communication with follower devices on the shared bus.

Controller 204 may include a media access circuit 306A, which may be responsible for managing media access control functions within the controller 204. The controller 204 may also include peripherals 302A connected to a microcontroller 304A. The microcontroller 304A may interface with the media access circuit 306A to provide overall control and coordination of the controller's functions.

The follower device 208 may comprise several components that enable it to communicate on the shared bus and interact with the controller 204. The follower device 208 may include peripherals 302B connected to a microcontroller 304B. The microcontroller 304B may be responsible for managing the overall operation of the follower device 208.

The microcontroller 304B in the follower device 208 may interface with a media access circuit 306B. The media access circuit 306B may be connected to a control circuit 300B and a 10 Base T1 physical layer circuit 308B. The control circuit 300B may handle protocol processing and management functions specific to the follower device 208, while the 10 Base T1 physical layer circuit 308B may enable communication with the controller 204 over the shared bus.

The components within the controller 204 and follower device 208 may interact to enable virtual port switching over the shared bus. For example, when the controller 204 needs to send data to a specific follower device, control circuit 300A may prepare the data for transmission. The data may be sent out through the 10 Base T1 physical layer circuit 308A onto the shared bus.

On the follower device 208 side, incoming data may be received by the 10 Base T1 physical layer circuit 308B and passed to the media access circuit 306B. The control circuit 300B may process the received data, and the microcontroller 304B may determine how to handle the information based on the virtual port, MAC address, or SC it was addressed to or on.

The 100 Base T1 MACSec physical interface circuit 312 may be implemented using any suitable combination of hardware and software components capable of providing Media Access Control security functions for 100BASE-T1 Ethernet communications. The 10 Base T1 physical layer circuit 308A may be implemented using any suitable transceiver technology compatible with the 10BASE-T1s specification.

The switch circuit 310 in the controller 204 may be implemented using any suitable switching hardware, potentially including a field-programmable gate array (FPGA) or application-specific integrated circuit (ASIC) to enable flexible configuration of virtual ports.

The control circuits 300 may be implemented with analog circuitry, digital circuitry, an FPGA, an ASIC, programmable logic device, combinatorial logic, instructions for execution by a processor, or any suitable combination thereof. Media access circuits 306 may be implemented with analog circuitry, digital circuitry, an FPGA, an ASIC, programmable logic device, combinatorial logic, instructions for execution by a processor, or any suitable combination thereof. In the follower device 208, the 10 Base T1 physical layer circuit 308B may be implemented using similar technology to its counterpart in the controller 204, tailored for the specific requirements of a follower device. The controller 204 may be implemented as a single integrated circuit or as a combination of discrete components on a printed circuit board. In some cases, the controller 204 may be realized as part of a system-on-chip (SoC) that integrates multiple functions. The 100 Base T1 MACSec physical interface circuit 312 may be implemented using a dedicated MACSec-capable PHY chip or as part of an integrated Ethernet controller. This circuit may include hardware acceleration for encryption and authentication operations to support MACSec protocols. The media access circuits 306 may be implemented as part of an Ethernet controller chip or as a separate MAC component. It may include hardware for frame formation, addressing, and error detection. The 3-port switch circuit 310 may be realized using a small Ethernet switch chip or implemented in programmable logic such as an FPGA. In some cases, it may be integrated into a multi-function Ethernet controller. The 10 Base T1 physical layer circuits 308 may be implemented using a PHY chip designed for automotive applications, specifically supporting the 10BASE-T1S standard. The peripherals 302 may include various input/output interfaces, timers, and communication modules implemented either as part of an integrated microcontroller or as separate chips on the circuit board. The microcontrollers 304 may be implemented using a general-purpose microcontroller chip or a specialized automotive-grade processor. In some cases, it may be integrated into a larger SoC that includes other controller functions.

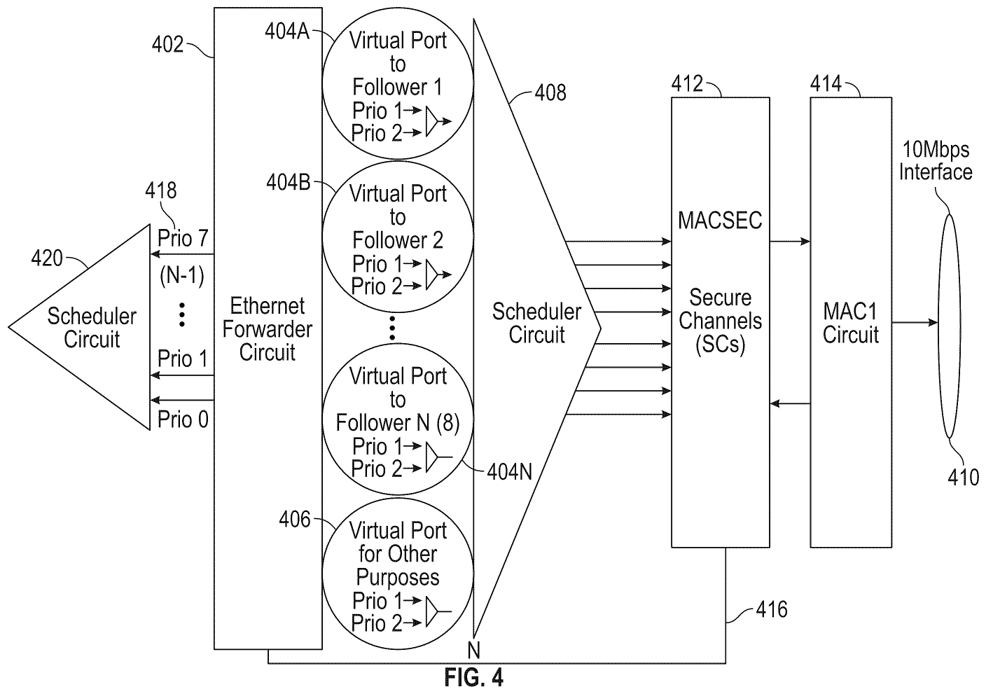

FIG. 4 is an illustration of a block diagram of a virtual port switching system for a shared network bus, according to examples of the present disclosure.

The virtual port switching system illustrated in FIG. 4 may represent an example implementation of the control circuit 300A shown in FIG. 3. This system may provide a more detailed view of how the control circuit 300A may manage data flow and virtual port switching within the controller 204.

In this implementation, the Ethernet forwarder circuit 402 may correspond to core functionality of the control circuit 300A. The Ethernet forwarder circuit 402 may include multiple virtual ports, such as the first virtual port 404A, second virtual port 404B, and extending to the nth virtual port 404N. These virtual ports may enable the control circuit 300A to manage communications with individual follower devices on the shared bus.

The scheduler circuit 408 and scheduler module 420 may be components within the control circuit 300A that manage traffic flow between the virtual ports and the physical shared bus interface.

The MACSec circuit 412 and MAC circuit 414 in FIG. 4 may correspond to security and media access control functions that the control circuit 300A may perform or coordinate within the controller 204. These components may work in conjunction with the 100 Base T1 MACSec physical interface circuit 312 and the media access circuit 306A shown in FIG. 3.

By implementing this virtual port switching system, the control circuit 300A may enable the controller 204 to efficiently manage communications between the upstream entity and multiple follower devices on the shared bus, while providing the functionality of a switched network topology.

The virtual port switching system may include an Ethernet forwarder circuit 402. The Ethernet forwarder circuit 402 may be implemented with analog circuitry, digital circuitry, an FPGA, an ASIC, programmable logic device, combinatorial logic, instructions for execution by a processor, or any suitable combination thereof. The Ethernet forwarder circuit 402 may interface between upstream outputs 418 and a downstream shared bus interface.

The Ethernet forwarder circuit 402 may include multiple virtual ports, including a first virtual port 404A, a second virtual port 404B, and extending to an nth virtual port 404N for connecting to corresponding follower devices. The virtual ports may be implemented as logical interfaces within the Ethernet forwarder circuit 402, potentially using memory buffers and control logic to manage data flow. An auxiliary virtual port 406 may also be provided for handling broadcast, multicast or other group communications.

A scheduler circuit 408 may connect to the virtual ports and manage traffic flow between them. The scheduler circuit 408 may be implemented with analog circuitry, digital circuitry, an FPGA, an ASIC, programmable logic device, combinatorial logic, instructions for execution by a processor, or any suitable combination thereof, and using any suitable scheduling algorithm, such as weighted round-robin or priority-based scheduling.

A scheduler circuit 420 may provide priority-based scheduling capabilities, with priority levels from 0 to N−1. The scheduler circuit 420 may be implemented as part of the scheduler circuit 408 or as a separate component running, for example, on a microcontroller within the system. The system may include a MACSec circuit 412 that provides security functions for communications over the shared bus. The MACSec circuit 412 and scheduler circuit 420 may be implemented with analog circuitry, digital circuitry, an FPGA, an ASIC, programmable logic device, combinatorial logic, instructions for execution by a processor, or any suitable combination thereof. The MACSec circuit 412 may connect to a MAC circuit 414 that handles media access control functions. The MAC circuit 414 may be implemented with analog circuitry, digital circuitry, an FPGA, an ASIC, programmable logic device, combinatorial logic, instructions for execution by a processor, or any suitable combination thereof. The MAC circuit 414 may interface with a 10 Mbps interface 410 that connects to the shared bus. The 10 Mbps interface 410 may represent the interface between the control circuit 300A and the 10 Base T1 physical layer circuit 308A shown in FIG. 3. The 10 Mbps interface 410 may be implemented using any suitable physical layer transceiver compatible with the 10BASE-T1s specification.

A feedback path 416 may be provided between the mac circuit 414 and the MACSec circuit 412. This feedback path 416 may allow for coordination between MAC-layer operations and security functions.

The virtual ports 404A-404N may be mapped to the physical shared bus interface through the scheduler circuit 408. Each virtual port may be configured with different priority levels, such as high priority and low priority. The mapping of virtual ports to the downstream network interface may be accomplished using any suitable method, such as pin-strapping or through management software.

The Ethernet forwarder circuit 402 may be configured to receive a frame to be forwarded to a given follower through an associated virtual port or virtual ports. Upon receiving the frame, the Ethernet forwarder circuit 402 may determine the virtual port based on the frame's destination MAC address matches the MAC address of each of the one or more N follower devices mapped to the given virtual port. This process may involve consulting a lookup table or other data structure maintained within the Ethernet forwarder circuit 402.

After determining the appropriate virtual ports and MAC addresses, the Ethernet forwarder circuit 402 may encode the frame for one or more secure channels between the Ethernet forwarder circuit 402 and the one or more of the N follower devices mapped to the given virtual port. This encoding process may result in one or more differently encoded copies of the frame.

The Ethernet forwarder circuit 402 may then forward the one or more differently encoded copies of the frame to the N follower devices on the network shared bus. This forwarding may be managed by the scheduler circuit 408, which may determine the appropriate transmission opportunities for each frame based on the priority levels of the virtual ports and the current state of the shared bus.

The Ethernet forwarder circuit 402 may support frame bursting within the same transmit opportunity. This capability may allow for more efficient use of the shared bus bandwidth, particularly when transmitting multiple frames to the same follower device or group of devices.

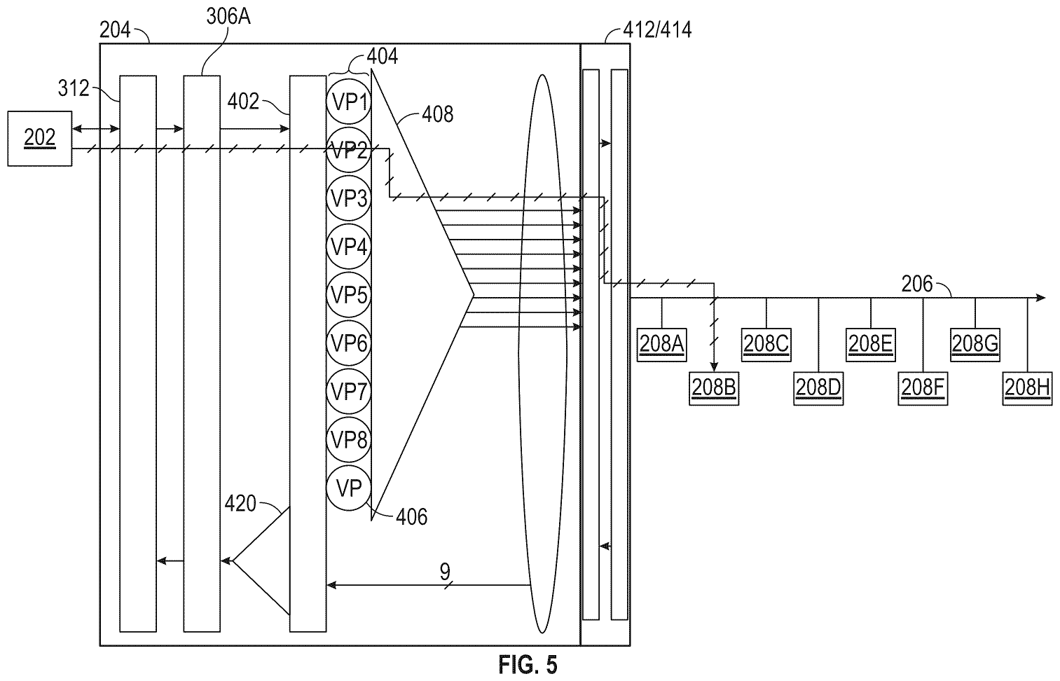

FIG. 5 is an illustration of operation of a virtual port switching system for unicast forwarding, according to examples of the present disclosure.

In switched Ethernet, a switch forwards a frame copy out the physical port to where the Destination Node is located. One frame or packet copy is sent out on one link, and in reply. There is a 1:1 MACsec secure channel between the switch and a given node.

In contrast, in the apparatus, in the direction from controller to the follower, one frame copy is forwarded to the virtual port of the destination follower. A copy of the frame is sent out on the 10BASE-T1s network. There is a single 1:1 MACsec SC relationship between the controller and a given destination follower. The copy of the frame is encoded with the address or designation of the destination follower to which the frame is to be sent. While other followers may receive the frame, the frame may be encoded by MACsec such that only the destination follower may have the cryptographic key or other mechanism to decode the frame.

In the direction from a source follower to the controller, the frame copy may be encoded with the SC between the controller and the follower. Thus, the other followers may receive the frame, but the frame may be encoded such that only the controller may have the cryptographic key or other mechanism to decode the frame. The frame may be decoded and sent to its further destination upstream.

Thus, both downstream and upstream unicast communication may be performed with a 1:1 SC relationship between a given follower and the controller.

The Ethernet forwarder circuit 402 may be configured to implement unicast forwarding to a given device of the N follower devices. For example, the Ethernet forwarder circuit 402 may forward a downstream frame to the shared bus 206. In this case, the controller 204 and the given follower device may share a unique secured channel among N unique secured channels between the controller 204 and given ones of the N follower devices.

For unicast forwarding of the downstream frame to the given follower device, a single copy of the downstream frame may be forwarded to the shared bus 206. A single secured channel may be shared from the controller 204 to the given follower device. Other follower devices may have physical access to the downstream frame through the shared bus 206 but may be prevented logical access to the downstream frame by the single secured channel.

The Ethernet forwarder circuit 402 may receive a frame from the upstream entity 202 intended for follower device 208B. Upon receiving the frame, the Ethernet forwarder circuit 402 may determine the destination virtual port 404 (VP2) as the frame's destination MAC address is equal to the MAC address of follower device 208B by consulting a lookup table or other data structure maintained within the circuit. The association between a follower device's MAC address and a virtual port might be programmed into Ethernet forwarder circuit 402 (or tables accessible thereto) as part of configuration of Ethernet forwarder circuit 402

The frame may then be passed to the MACSec circuit 412 and MAC circuit 414, where it may be encoded using a unique secure channel (SC) established between the controller 204 and follower device 208B. This encoding process may involve encryption and authentication operations to ensure the security of the communication.

After encoding, a single copy of the frame may be forwarded to the virtual port associated with follower device 208B.

The scheduler circuit 408 may then manage the transmission of the encoded frame over the shared bus 206 to follower device 208B. Other follower devices connected to the shared bus 206 may physically receive the frame but may be unable to decode or access its contents due to the unique secure channel used for encoding.

This approach may allow for efficient unicast communication over the shared bus while maintaining security and preventing unauthorized access to the frame's contents by other devices on the network.

The Ethernet forwarder circuit 402 may also be configured to implement unicast forwarding from a given device of the N follower devices. In this case, the Ethernet forwarder circuit 402 may forward an upstream frame from a given follower device on the shared bus 206 to the upstream entity 202. The controller 204 and the given follower device may share a unique secured channel among N unique secured channels between the controller 204 and given ones of the N follower devices. Other follower devices may have physical access to the upstream frame through the shared bus 206 and may be prevented logical access to the upstream frame by the unique secured channel.

For example, the Ethernet forwarder circuit 402 may forward an upstream frame from follower device 208B on the shared bus 206 to the upstream entity 202.

When follower device 208B needs to send a frame to the upstream entity 202, it may transmit the frame onto the shared bus 206. The frame may be encoded using a unique secure channel established between follower device 208B and controller 204. This may be a same or different unique secure channel as used to send frames between controller 204 to follower device 208B. This may be decoded by 412/414. After successful decoding and authentication, upon receiving the frame, the Ethernet forwarder circuit 402 may identify that the frame is from follower device 208B based on the secure channel used for encoding. The Ethernet forwarder circuit 402 may determine that the frame is intended for the upstream entity 202. The Ethernet forwarder circuit 402 may then forward the frame through the appropriate upstream interface, such as the 100 Base T1 MACSec physical interface circuit 312, to reach the upstream entity 202.

Throughout this process, other follower devices on the shared bus 206 may have physical access to the upstream frame but may be prevented from accessing its contents due to the unique secure channel used between follower device 208B and the controller 204.

This approach may allow for secure and efficient unicast communication from a follower device to the upstream entity over the shared bus, while maintaining the logical separation of traffic between devices.

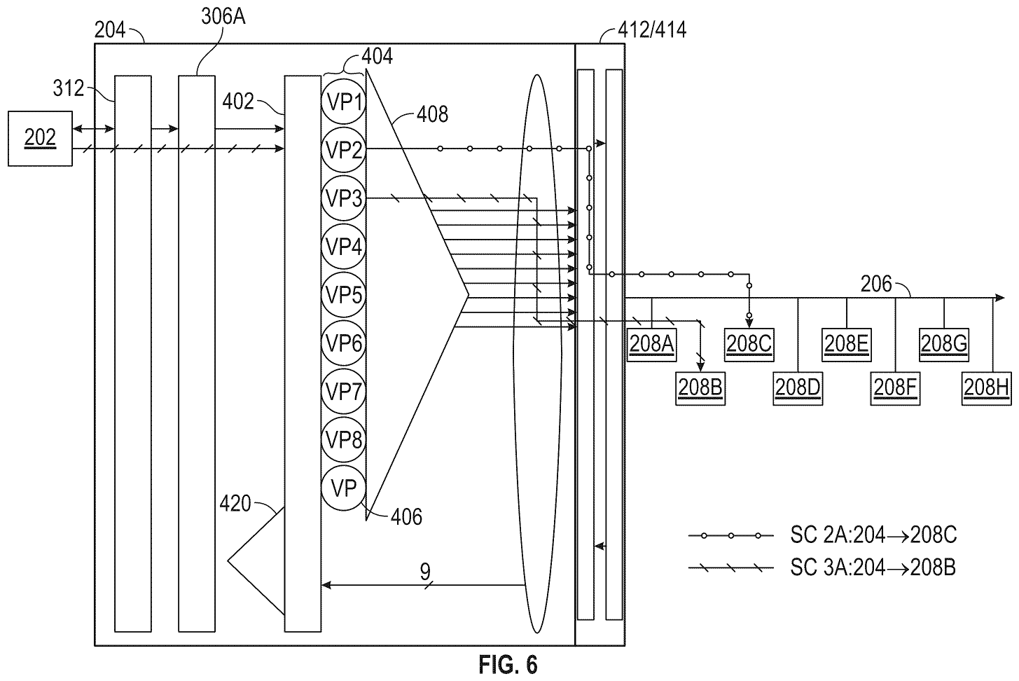

FIG. 6 is an illustration of operation of a virtual port switching system for broadcast forwarding, or flooding, wherein each node may have a single SC from the controller to a given node, according to examples of the present disclosure.

In a switched network, a frame copy is forwarded out on each switch port. There are 8 Frame copies in total-one per link. There is a 1:1 MACsec SC per link.

In the system, a frame copy is forwarded out each virtual port on the switch core. There may be 8 Frame copies in total-8 copies on 10BASE-T1s link (only three copies are shown). There may be a 1:1 MACsec SC between Controller and a given specific Follower (shown in illustration by using different colors.)

This may benefit from allowing Controller to burst over 10BASE-T1s within the same transmit opportunity. One SC in the Follower is sufficient for all traffic of a given kind (Unicast, flood, broadcast, etc.). However, one SC is used for each kind, meaning if there were multiple sub-groups or types for which a subset of the followers are to receive the broadcast, then additional SCs may be used for each such sub-group.

The Ethernet forwarder circuit 402 may be configured to implement frame broadcasting to the N follower devices. In this case, the Ethernet forwarder circuit 402 may forward separate copies of a downstream frame to each of the N follower devices over the shared bus 206. Each of the N follower devices may share a unique secured channel with the controller 204. Respective copies of the downstream frame may be sent to a given follower device of the N follower devices through a given secured channel from the given follower device to the controller 204.

For frame broadcasting, the separate copies of the downstream frame forwarded to each of the N follower devices over the shared bus 206 may result in N forwarded copies of the downstream frame over the shared bus 206. Each of the N follower devices may be configured to receive the N forwarded copies of the downstream frame and may access its own copy of the downstream frame through its respective unique secured channel.

In broadcast forwarding with one secure channel (SC) per follower, a frame may be sent from the upstream entity 202 to follower device 208B as follows.

The Ethernet forwarder circuit 402 may receive a broadcast frame from the upstream entity 202. Upon receiving the frame, the Ethernet forwarder circuit 402 may recognize it as a broadcast frame based on its destination address or other indicators.

The Ethernet forwarder circuit 402 may then create multiple copies of the frame, one for each follower device connected to the shared bus 206. For follower device 208B, a specific copy of the frame may be prepared.

This copy of the frame may be passed to the MACSec circuit 412 and MAC circuit 414, where it may be encoded using the unique secure channel established between the controller 204 and follower device 208B. The encoding process may involve encryption and authentication operations to ensure the security of the communication.

After encoding, the frame copy intended for follower device 208B may be queued in the virtual port associated with that device. The scheduler circuit 408 may then manage the transmission of this encoded frame, along with the encoded copies for other follower devices, over the shared bus 206.

When the frame reaches the shared bus 206, all follower devices, including 208B, may physically receive the transmission. However, only follower device 208B may be able to decode and access the contents of its specific copy due to the unique secure channel used for encoding.

This approach may allow for efficient broadcast communication over the shared bus while maintaining security. Each follower device may receive its own securely encoded copy of the broadcast frame, preventing unauthorized access to the frame's contents by other devices on the network.

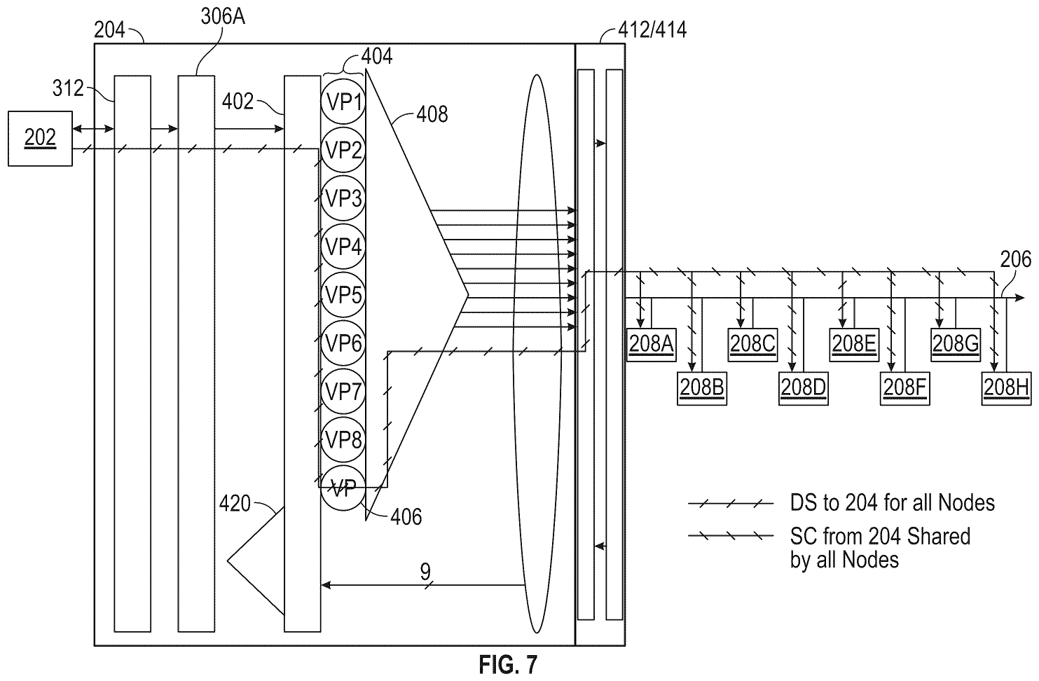

FIG. 7 is an illustration of operation of a virtual port switching system for broadcast forwarding, or flooding, wherein each node may share an additional SC from the controller to the given node for broadcasting, according to examples of the present disclosure.

This may address certain issues discussed above with respect to FIG. 6.

In a switched network, a frame copy is forwarded out on each switch port, with 8 frame copies in total—one per link. There may be a 1:1 MACsec SC per link.

In the system, a dedicated virtual port may be assigned to flood/broadcast for a specific group and then only send a single frame copy on the 10Base-T1s link. This may require that each follower now have at least two SCs: one SC for unicast where the follower is specifically targeted, and one SC for flood or broadcast where all followers are targeted, or a subset thereof. There might be no bandwidth/delay penalty.

The Ethernet forwarder circuit 402 may be configured to implement frame broadcasting to the N follower devices using a secured channel that may be common from the controller 204 to all of the N follower devices. The Ethernet forwarder circuit 402 may also maintain N unique secured channels, to each of the N follower devices, as discussed above. This may result in at least N+1 secured channels from the controller 204 to the N follower devices. This approach may allow for a single encoded frame to be sent and received by all follower devices, potentially reducing bandwidth usage and processing overhead compared to individual unicast transmissions.

When the Ethernet forwarder circuit 402 receives an inbound frame intended for broadcast, it may first determine that the frame should be sent using the common SC associated with virtual port 406. This determination may be based on the frame's destination address, frame type, or other indicators within the frame or associated metadata, such as a designation to broadcast the frame.

The Ethernet forwarder circuit 402 may then pass the frame to the MACSec circuit 412 and MAC circuit 414 for encoding. In this case, the encoding process may use the common SC shared by all follower devices. This encoding may involve encryption and authentication operations to ensure the security of the communication while allowing all intended recipients to access the frame's contents.

After encoding, a single copy of the frame may be queued in the auxiliary virtual port 406, which may be designated for broadcast or multicast communications. The scheduler circuit 408 may then manage the transmission of this encoded frame over the shared bus 206.

When the frame reaches the shared bus 206, all follower devices may physically receive the transmission. Unlike in unicast scenarios, where only the intended recipient can decode the frame, in this broadcast scenario, all follower devices may be able to decode and access the contents of the frame using the common SC.

Only one copy of the frame needs to be transmitted over the shared bus, potentially reducing network congestion. The controller 204 may only need to encode the frame once, rather than creating multiple individually encoded copies. Maintaining a single common SC for broadcast communications may be easier than managing individual SCs for each follower device. All follower devices may receive the broadcast frame simultaneously, which may be important for certain applications requiring synchronized updates or actions across multiple devices.

The Ethernet forwarder circuit 402 may be designed to seamlessly switch between using individual SCs for unicast communications and the common SC for broadcast communications, allowing for flexible and efficient use of the shared bus 206 based on the specific communication needs at any given time.

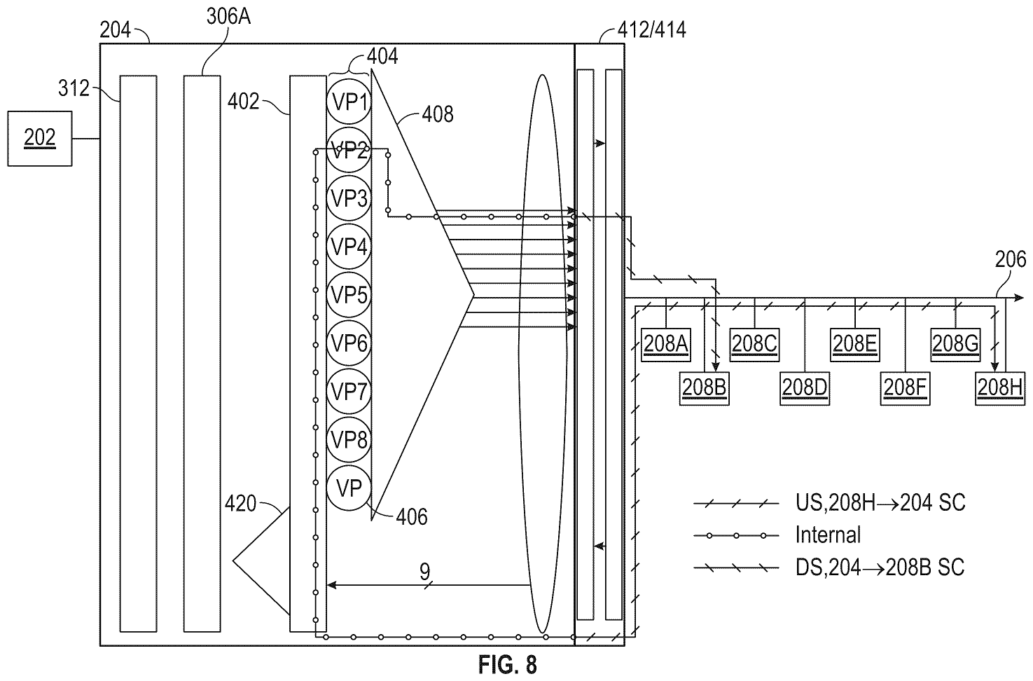

FIG. 8 is an illustration of operation of a virtual port switching system for follower-to-follower communication, wherein one SC is provided for each follower, according to examples of the present disclosure.

In a switched network, there may be a 1:1 MACsec SC per link.

In the system, without MACsec there may be no need to go through the controller. With MACsec, there may be 1 frame copy over 1:1 MACsec SC for, for example, for sending from Follower 8 to the controller. There may be hairpin switching in the forwarder from Virtual Port 8 to Virtual Port 2. Then, there may be 1 frame copy over 1:1 MACsec SC from the controller to receiving Follower 2.

Thus, in the case of follower-to-follower communication with one secure channel (SC) per follower, a frame may be sent from follower device 208H to follower device 208B as follows:

Follower device 208H may transmit the frame onto the shared bus 206. The frame may be encoded using the unique secure channel established between follower device 208H and the controller 204.

The Ethernet forwarder circuit 402 may receive the encoded frame from the shared bus 206. The MACSec circuit 412 and MAC circuit 414 may decode the frame using the secure channel associated with follower device 208H. After successful decoding and authentication, the Ethernet forwarder circuit 402 may identify that the frame is from follower device 208H based on the secure channel used for encoding.

The Ethernet forwarder circuit 402 may then examine the frame's destination address and determine that it is intended for follower device 208B. Instead of forwarding the frame to the upstream entity 202, the Ethernet forwarder circuit 402 may prepare to send the frame back out to the shared bus 206.

When the frame has been decrypted as described above, then such a frame may be hairpinned without modifications by Ethernet forwarder circuit 402. When the frame is forwarded to a virtual port and is on the way to 208B then the frame may be encrypted according to the SC between 204 and 208B.

After encoding, the new frame may be queued in the virtual port VP2 associated with follower device 208B within the virtual ports 404 of the Ethernet forwarder circuit 402. The scheduler circuit 408 may then manage the transmission of this encoded frame over the shared bus 206.

When the frame reaches the shared bus 206, all follower devices may physically receive the transmission. However, only follower device 208B may be able to decode and access the contents of the frame due to the unique secure channel used for encoding between the controller 204 and follower device 208B.

This approach may allow for secure and efficient communication between follower devices over the shared bus, while maintaining the logical separation of traffic and preventing unauthorized access to the frame's contents by other devices on the network. The Ethernet forwarder circuit 402 may effectively act as an intermediary, receiving and retransmitting the frame between the two follower devices using their respective secure channels.

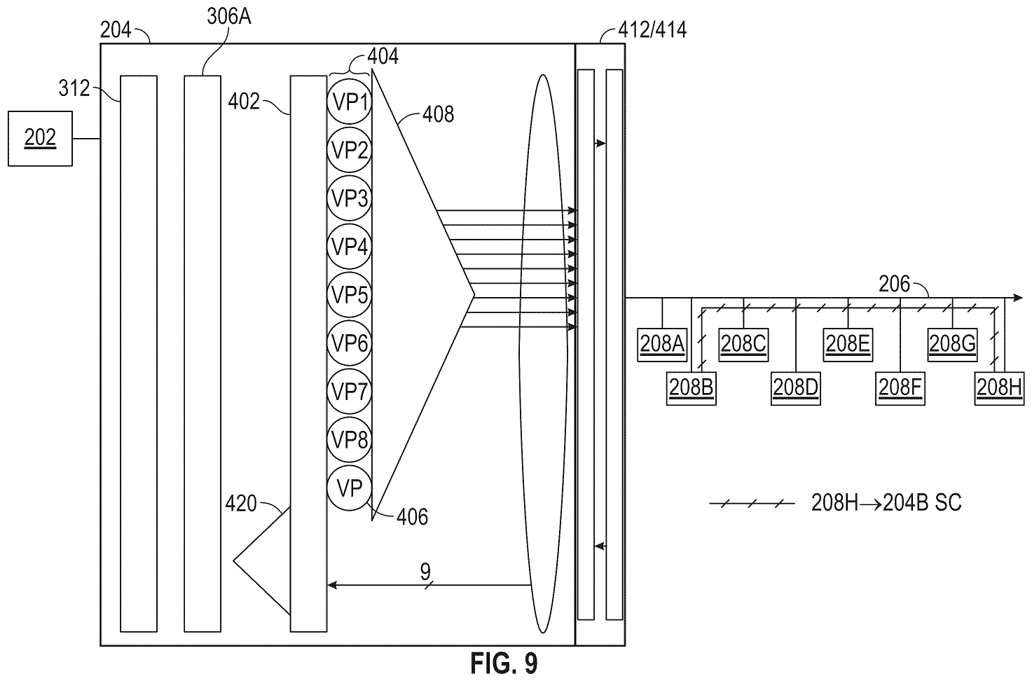

FIG. 9 is an illustration of the operation of a virtual port switching system for follower-to-follower communication, wherein three SCs are provided for each follower, according to examples of the present disclosure. Three is used as an example, though any suitable number may be used.

In a switched network, there may be a 1:1 MACsec SC per link.

In the system, if followers support multiple SCs, the need to go through the controller may be omitted. For example, there may be a dedicated SC for communication between Followers 8 and 2. This process may be combined with hair pinning. Furthermore, there may be such a dedicated SC for communication between Followers 2 and 8. Each such follower may also include an SC to receive frames from the controller. The follower to follower having a dedicated SC between them may operate without the controller being involved in the forwarding. The controller might not know the keys used in such an SA from 2 to 8, or an SA from 8 to 2. The controller will see the frames between 208H and 208B due to the shared bus, but it will not be able to decrypt the frames.

In the case of follower-to-follower communication with three secure channels (SCs) per follower, a frame may be sent from follower device 208H to follower device 208B as follows.

Follower device 208H may transmit the frame onto the shared bus 206. The frame may be encoded using a first one of the three unique secure channels, established between follower device 208H and follower device 208B. This SC may be designated for upstream communication from 208H to 208B. Only 208B will know how to decrypt this frame. All other followers (and the controller) will not be able to decrypt.

All follower devices may physically receive the transmission. However, only follower device 208B may be able to decode and access the contents of the frame due to the unique secure channel used for encoding between the controller 204 and follower device 208B.

Each follower that has three SCs available may be able to take advantage of such node-to-node communication, wherein one such SC is available to forward frames from one node to another such node. Another SC may be available to forward frames in the reverse, from another such node back to the first node. The third SC may be for communication from the controller to the given node.

This approach with multiple secure channels per follower may provide enhanced flexibility and security in managing different types of traffic flows. The hair pinning capability may allow for more efficient follower-to-follower communication by reducing latency and processing overhead associated with routing through upstream components.

In the above examples, with nine nodes on a 10BASE-T1s shared bus and any-to-any connectivity and considering unicast only, using standard Ethernet switching as shown in FIG. 1, all 9 nodes might use at least 8 SCs, for a total of 72 SCs.

In contrast, the system may include a controller that uses 8 SCs (one per follower). Each Follower need one SC only for the 1:1 connection to the controller. This may result in a total of (8+8=16) SCs with 9 nodes on shared bus for full support for unicast, multicast, broadcast, and flooding.

A tradeoff may include bandwidth utilization over 10BASE-T1s technology. Replicated frames are sent multiple times onto the shared bus. However, the effect of such traffic may be accommodated. Flooding is a fundamental connectivity requirement in Ethernet. Moreover, allowing the controller to burst multiple frames in the same transmit opportunity (TO) may alleviate some of the latency increase.

For follower-to-follower, communication delay may increase. TO delay in the controller can be reduced by assigning more bandwidth than 1/(N+1), along with frame burst being enabled in the controller. Receiving followers discard frame copies with a respective DMAC, but that is encrypted with keys of an SC it is not a member of. If follower-to-follower communication exists, it is expected to be low bandwidth and might not be timing critical.

Examples of the present disclosure may include an upstream network interface, a downstream network interface to configured to connect to N follower devices on a shared network bus, and an Ethernet forwarder circuit with at least N+1 virtual ports. The N+1 virtual ports may include a given virtual port for a given one of the N follower devices and at least one given virtual port for a group of two or more of the N follower devices.

In combination with any of the above examples, to implement a given virtual port the Ethernet forwarder circuit may be configured to map the given virtual port to one or more of the N follower devices to upstream devices, receive a frame to be forwarded to the given virtual port. The Ethernet forwarder circuit may be configured to, based on a MAC address of the frame, encode the frame for one or more secure channels between the Ethernet forwarder circuit and the one or more of the N follower devices, resulting in one or more differently encoded copies of the frame. The Ethernet forwarder circuit may be configured to forward the one or more differently encoded copies of the frame to the N follower devices on the network shared bus.

In combination with any of the above examples, the Ethernet forwarder circuit may be configured to implement unicast forwarding to a given device of the N follower devices, wherein the Ethernet forwarder circuit is to forward a downstream frame to the shared network bus, and the apparatus and the given device share a unique secured channel among N unique secured channels between the apparatus and given ones of the N follower devices.

In combination with any of the above examples, to implement unicast forwarding of the downstream frame to the given device, a single copy of the downstream frame may be forwarded to the shared network bus, a single secured channel is shared from the apparatus to the given device, and others of the N follower devices have physical access to the downstream frame through the shared bus and are prevented logical access to the downstream frame by the single secured channel.

In combination with any of the above examples, the Ethernet forwarded circuit may be configured to implement unicast forwarding from a given device of the N follower devices, wherein the Ethernet forwarder circuit may be configured to forward an upstream frame from a given device on the shared network bus to an upstream device, wherein the apparatus and the given device share a unique secured channel among N unique secured channels between the apparatus and given ones of the N follower devices, and others of the N follower devices have physical access to the upstream frame through the shared bus and are prevented logical access to the upstream frame by the unique secured channel.

In combination with any of the above examples, the Ethernet forwarder circuit is configured to implement frame broadcasting to the N follower devices, wherein the Ethernet forwarder circuit may be configured to forward separate copies of a downstream frame to each of the N follower devices over the shared network bus, each of the N follower devices shares a unique secured channel with the apparatus, and respective copies of the downstream frame are sent to a given device of the N follower devices through a given secured channel from the given device to the apparatus.

In combination with any of the above examples, to implement frame broadcasting of the downstream frame to the N follower devices, the separate copies of the downstream forwarded to the each of the N follower devices over the shared network bus may result in N forwarded copies of the downstream frame over the shared bus, and each of the N follower devices is configured to receive the N forwarded copies of the downstream frame and will access its own copy of the downstream frame through its respective unique secured channel.

In combination with any of the above examples, the Ethernet forwarder circuit may be configured to implement frame broadcasting to the N follower devices, wherein the Ethernet forwarder circuit may be configured to forward a copy of a downstream frame over the shared network bus using a secured channel that is common from the apparatus to the N follower devices.

In combination with any of the above examples, the Ethernet forwarder circuit may be configured to maintain N unique secured channels, the N unique secured channels to include a unique secured channel from the apparatus to a given device of the N follower devices, resulting in at least N+1 secured channels from the apparatus to the N follower devices.

In combination with any of the above examples, the Ethernet forwarder circuit may be configured to implement device-to-device communication between two of the N follower devices through a first unique secured channel between a first device of the N follower devices and the apparatus and a second unique secured channel between a second device of the N follower devices and the apparatus. The Ethernet forwarder circuit may be configured to receive an upstream frame from the first device from the shared network bus over the first unique secured channel, repackage contents of the upstream frame into a downstream frame, and forward the downstream frame over the shared network bus to the second device over the second unique secured channel.

In combination with any of the above examples, the Ethernet forwarder circuit may be configured to implement device-to-device communication between two of the N follower devices through a first unique secured channel between a first device of the N follower devices and a second device of the N follower devices, wherein the first device of the N follower devices is configured to provide a frame on the shared network bus that is received by two or more of the N follower devices but is decryptable by the second device of the N follower devices.

Although examples have been described above, other variations and examples may be made from this disclosure without departing from the spirit and scope of these examples.

We claim:

1. An apparatus, comprising:
an upstream network interface;
a downstream network interface to configured to connect to N follower devices on a shared network bus; and
an Ethernet forwarder circuit with at least N+1 virtual ports, the N+1 virtual ports including a given virtual port for a given one of the N follower devices and at least one given virtual port for a group of two or more of the N follower devices.

2. The apparatus of claim 1, wherein to implement a given virtual port the Ethernet forwarder circuit is configured to:
map the given virtual port to one or more of the N follower devices to upstream devices;
receive a frame to be forwarded to the given virtual port;
based on a MAC address of the frame, encode the frame for one or more secure channels between the Ethernet forwarder circuit and the one or more of the N follower devices, resulting in one or more differently encoded copies of the frame; and
forward the one or more differently encoded copies of the frame to the N follower devices on the network shared bus.

3. The apparatus of claim 1, wherein the Ethernet forwarder circuit is configured to implement unicast forwarding to a given device of the N follower devices, wherein the Ethernet forwarder circuit is to forward a downstream frame to the shared network bus, and the apparatus and the given device share a unique secured channel among N unique secured channels between the apparatus and given ones of the N follower devices.

4. The apparatus of claim 2, wherein to implement unicast forwarding of the downstream frame to the given device, a single copy of the downstream frame is forwarded to the shared network bus, a single secured channel is shared from the apparatus to the given device, and others of the N follower devices have physical access to the downstream frame through the shared bus and are prevented logical access to the downstream frame by the single secured channel.

5. The apparatus of claim 1, wherein the Ethernet forwarded circuit is configured to implement unicast forwarding from a given device of the N follower devices, wherein the Ethernet forwarder circuit is configured to forward an upstream frame from a given device on the shared network bus to an upstream device, wherein the apparatus and the given device share a unique secured channel among N unique secured channels between the apparatus and given ones of the N follower devices, and others of the N follower devices have physical access to the upstream frame through the shared bus and are prevented logical access to the upstream frame by the unique secured channel.

6. The apparatus of claim 1, wherein the Ethernet forwarder circuit is configured to implement frame broadcasting to the N follower devices, wherein the Ethernet forwarder circuit is configured to forward separate copies of a downstream frame to each of the N follower devices over the shared network bus, each of the N follower devices shares a unique secured channel with the apparatus, and respective copies of the downstream frame are sent to a given device of the N follower devices through a given secured channel from the given device to the apparatus.

7. The apparatus of claim 6, wherein to implement frame broadcasting of the downstream frame to the N follower devices, the separate copies of the downstream forwarded to the each of the N follower devices over the shared network bus will result in N forwarded copies of the downstream frame over the shared bus, and each of the N follower devices is configured to receive the N forwarded copies of the downstream frame and will access its own copy of the downstream frame through its respective unique secured channel.

8. The apparatus of claim 1, wherein the Ethernet forwarder circuit is configured to implement frame broadcasting to the N follower devices, wherein the Ethernet forwarder circuit is configured to forward a copy of a downstream frame over the shared network bus using a secured channel that is common from the apparatus to the N follower devices.

9. The apparatus of claim 8, wherein the Ethernet forwarder circuit is configured to maintain N unique secured channels, the N unique secured channels to include a unique secured channel from the apparatus to a given device of the N follower devices, resulting in at least N+1 secured channels from the apparatus to the N follower devices.

10. The apparatus of claim 1, wherein the Ethernet forwarder circuit is configured to implement device-to-device communication between two of the N follower devices through a first unique secured channel between a first device of the N follower devices and the apparatus and a second unique secured channel between a second device of the N follower devices and the apparatus, wherein the Ethernet forwarder circuit is configured to:
receive an upstream frame from the first device from the shared network bus over the first unique secured channel;
repackage contents of the upstream frame into a downstream frame; and
forward the downstream frame over the shared network bus to the second device over the second unique secured channel.

11. The apparatus of claim 1, wherein the Ethernet forwarder circuit is configured to implement device-to-device communication between two of the N follower devices through a first unique secured channel between a first device of the N follower devices and a second device of the N follower devices, wherein the first device of the N follower devices is configured to provide a frame on the shared network bus that is received by two or more of the N follower devices but is decryptable by the second device of the N follower devices.

12. The apparatus of claim 11, wherein the Ethernet forwarder circuit is configured to implement device-to-device communication between two of the N follower devices through a second unique secured channel between the second device of the N follower devices and the first device of the N follower devices, wherein the second device of the N follower devices is configured to provide a frame on the shared network bus that is received by two or more of the N follower devices but is decryptable by the first device of the N follower devices.

13. A method, comprising, at an apparatus:
monitoring an upstream network interface;
connecting, through a downstream network interface, to N follower devices on a shared network bus; and
with at least N+1 virtual ports, the N+1 virtual ports including a given virtual port for a given one of the N follower devices and at least one given virtual port for a group of two or more of the N follower devices, transferring frames between the N follower devices or between an upstream device connected to the upstream network interface and one or more of the N follower devices.

14. The method of claim 13, wherein to implement a given virtual port the method comprises:
mapping the given virtual port to one or more of the N follower devices to upstream devices;
receiving a frame to be forwarded to the given virtual port;
based on a MAC address of the frame, encoding the frame for a secure channel between the Ethernet forwarder circuit and the one or more of the N follower devices, resulting in one or more differently encoded copies of the frame; and
forwarding the one or more differently encoded copies of the frame to the N follower devices on the network shared bus.

15. The method of claim 13, comprising implementing unicast forwarding to a given device of the N follower devices by forwarding a downstream frame to the shared network bus, and causing the apparatus and the given device to share a unique secured channel among N unique secured channels between the apparatus and given ones of the N follower devices.

16. The method of claim 15, comprising implementing unicast forwarding of the downstream frame to the given device by forwarding a single copy of the downstream frame to the shared network bus, sharing a single secured channel is shared from the apparatus to the given device, and providing others of the N follower devices with physical access to the downstream frame through the shared bus but preventing logical access to the downstream frame by the single secured channel.

17. The method of claim 13, comprising implementing unicast forwarding from a given device of the N follower devices by forwarding an upstream frame from a given device on the shared network bus to an upstream device, wherein the apparatus and the given device share a unique secured channel among N unique secured channels between the apparatus and given ones of the N follower devices, and others of the N follower devices have physical access to the upstream frame through the shared bus and are prevented logical access to the upstream frame by the unique secured channel.

18. The method of claim 13, comprising implementing frame broadcasting to the N follower devices by forwarding separate copies of a downstream frame to each of the N follower devices over the shared network bus, wherein each of the N follower devices shares a unique secured channel with the apparatus, and respective copies of the downstream frame are sent to a given device of the N follower devices through a given secured channel.

19. The method of claim 18, comprising implementing frame broadcasting of the downstream frame to the N follower devices by forwarding separate copies of the downstream forwarded to the each of the N follower devices over the shared network bus to result in N forwarded copies of the downstream frame over the shared bus, wherein each of the N follower devices is configured to receive the N forwarded copies of the downstream frame and will access its own copy of the downstream frame through its respective unique secured channel.

20. The method of claim 13, comprising implementing frame broadcasting to the N follower devices by forwarding a copy of a downstream frame over the shared network bus using a secured channel that is common from the apparatus to the N follower devices.
